(19) United States
(12) Patent Application Publication
(10) Pub. No.: US 2020/0283067 A1
(43) Pub. Date: Sep. 10, 2020

(54) TWIST-BEAM AXLE FOR AN ELECTRICALLY DRIVEN MOTOR VEHICLE

(71) Applicant: BENTELER AUTOMOBILTECHNIK GMBH, Paderborn (DE)

(72) Inventors: Hendrik REINEKE, Bad Driburg (DE); Drabon RODSCHA, Salzkotten (DE); Erik SCHULTZ, Paderborn (DE)

(73) Assignee: BENTELER AUTOMOBILTECHNIK GMBH, Paderborn (DE)

(21) Appl. No.: 16/809,808

(22) Filed: Mar. 5, 2020

(30) Foreign Application Priority Data
Mar. 5, 2019 (DE) DE102019105497.4

(51) Int. Cl. B62D 21/02; B62D 21/08; B62D 25/20; B62D 3/00; B60G 7/00; B60G 15/06; B60K 1/00

(52) U.S. Cl. CPC B62D 21/02; B62D 21/08; B62D 25/20; B60K 1/00; B60G 7/005; B60G 15/068; B62D 3/00

(57) ABSTRACT

The invention relates to a twist-beam axle for an electrically driven motor vehicle which is provided on the motor vehicle floor with at least one battery tray, having longitudinal links which are each assigned to a wheel carrier of the axle and which are connected to one another via a crossmember and at one end of which a respective wheel carrier is arranged, wherein the longitudinal links, at the end opposite to the respective wheel carrier, are connected by means of rubber bearings to the battery tray arranged on the motor vehicle floor, to a longitudinal member or crossmember in the floor region of the motor vehicle or to a frame of the motor vehicle.

### CROSS-REFERENCE TO RELATED APPLICATIONS

This application claims the benefit of Germany Patent Application No. DE 10 2019 105 497.4 filed Mar. 5, 2019, the entire disclosure of which is incorporated herein by reference in its entirety.

### FIELD

The invention relates to a twist-beam axle for an electrically driven motor vehicle.

### BACKGROUND

DE 31 18 177 A1 discloses a wheel suspension for steerable front wheels in which a twist-beam axle is used, the longitudinal or oblique links articulated on the wheel carrier being articulated on the vehicle body via rubber bearings. However, even in these wheel suspensions, there continues to be the problem of height difference between the center of gravity of the motor vehicle and the roll center, resulting in turn in heavy rolling of the motor vehicle during cornering.

### SUMMARY

It is therefore an object of the invention to provide a wheel suspension or a twist-beam axle for an electrically driven motor vehicle in which heavy rolling during cornering is reduced, which additionally consists of few individual parts and thus can be assembled simply without complex assembly operations, and is additionally cost-effective. Furthermore, it is an object of the invention to provide a motor vehicle having at least one such twist-beam axle in which heavy rolling during cornering is reduced.

With regard to the wheel suspension or the twist-beam axle, the object is achieved by a twist-beam axle having all the features of patent claim 1. With regard to the motor vehicle, the object is achieved by a motor vehicle having all features of patent claim 10. Advantageous embodiments of the invention can be found in the dependent claims.

The wheel suspension or twist-beam axle according to the invention for an electrically driven motor vehicle which is provided on the motor vehicle floor with at least one battery tray, having longitudinal links which are each assigned to a wheel carrier of the axle and which are connected to one another via a crossmember and at one end of which a respective wheel carrier is arranged, the longitudinal links, at the end opposite to the respective wheel carrier, being connected by means of rubber bearings to the at least one battery tray arranged on the motor vehicle floor, to a longitudinal member or crossmember in the floor region of the motor vehicle or to a frame of the motor vehicle.

Just like a conventional twist-beam axle, the twist-beam axle according to the invention here consists of a crossmember which connects two longitudinal links to one another. The longitudinal links serve here for the wheel suspension. By virtue of the fact that, in electrically driven motor vehicles, the batteries for energy storage are situated in a battery tray arranged on the floor of the motor vehicle and the batteries arranged therein make up a not inconsiderable proportion of the weight of the motor vehicle, the center of gravity of the motor vehicle is displaced significantly downward in the direction of the battery tray as a result of the arrangement of the batteries in a battery tray arranged on the floor of the motor vehicle. As a result, the center of gravity of the motor vehicle is lowered. It should only be mentioned here by way of example that the position of the center of gravity of an electrically driven motor vehicle is currently situated on average approximately at a height of 540 mm, whereas the roll center in conventional axle systems is situated approximately at a height of about 80 mm. This results in a rolling lever arm of about 460 mm. By contrast, the center of gravity of an electrically driven motor vehicle according to the invention having a twist-beam axle is situated approximately at a height of 450 mm, while the roll center height is situated as a rule between 200 mm and 400 mm. The lowering of the motor vehicle center of gravity on the one hand and the heightening of the roll center on the other hand affords a considerably more favorable rolling lever arm which is situated between 50 mm and 200 mm. As a result, rolling movements during cornering are considerably smaller.

This displacement or lowering of the center of gravity of the motor vehicle also considerably minimizes the height difference between the center of gravity and the roll center of the motor vehicle. This advantage appears noticeably in particular when using a twist-beam axle as a front axle, since such a front axle has a high roll center. In conjunction with the low center of gravity height of the electrical vehicle on account of the batteries arranged in the battery tray, the rolling lever arm is greatly reduced and hence also the rolling movement of the motor vehicle during cornering.

However, the use of the twist-beam axle according to the invention is not limited to a front axle.

Rather, a twist-beam axle according to the invention can also be used as a rear axle of a motor vehicle. Here, the axle is nondriven, as also occurs with twist-beam axles in motor vehicles having internal combustion engines. The kinematics here has an understeering roll steer, a high roll center and an oblique suspension angle.

By contrast, when using the twist-beam axle according to the invention as a front axle, the axle is driven. By virtue of the fact that, when using the twist-beam axle or wheel suspension according to the invention as a front axle of a motor vehicle, this front axle is driven, a roll-understeering behavior has to be realized. The roll center will be lower by comparison with the rear axle, with it particularly being able to be inclined downward to the front. An oblique suspension angle also occurs during the use as a front axle.

In principle, it is possible to equip both the front and the rear axle of an electrically driven motor vehicle with a twist-beam axle according to the invention, with it being possible for the twist-beam axles both to be designed to be steerable. This is advantageous particularly in the case of so-called people movers in order to achieve a very small turning circle and good maneuverability. Such people movers partially move already completely autonomously and can maneuver in a very tight space by means of steerable front and rear axles. However, it is also possible to design only the front or rear axle to be steerable.

According to a first advantageous embodiment of the invention, there is provision that the longitudinal links between the respective wheel carrier and the respective rubber bearing are formed so as to be bent with respect to the motor vehicle longitudinal axis. Such a configuration of the twist-beam axle is particularly expedient and also necessary when the twist-beam axle is provided with steerable wheel carriers. It is achieved and ensured by the bent shape of the longitudinal links with respect to the motor vehicle longitudinal axis that the wheels of a motor vehicle that are arranged on the wheel carriers have sufficient play, such that steering movements can be adequately carried out and are not limited by the longitudinal links. As a result, the maneuverability of a motor vehicle having at least one such wheel suspension or twist-beam axle is also further increased.

Particularly when using the twist-beam axle with steerable wheel carriers, it has proved to be advantageous to couple the respective wheel carriers to the respective longitudinal link by means of a ball joint and a damper unit. On the one hand, this ensures the movability of the wheel carrier, in particular for steering movements. On the other hand, improved ride comfort is achieved by the damper unit. This configuration here resembles that of a McPherson axle, with now, however, a transverse link no longer being necessary in the twist-beam axle. Such connections have already proved themselves in many applications in the automotive sector and can be produced reliably and cost- and time-efficiently.

Alternatively, it is of course also possible for the respective wheel carrier to be coupled to the respective longitudinal link by means of two bearings or two joints. It is also possible by means of such bearings for the wheel carriers to be securely arranged on the longitudinal link, this being particularly advantageous when the twist-beam axle is designed as a nonsteerable axle. In particular, the stability of the wheel guidance is optimized in this configuration. Such connections have also already proved themselves in many applications in the automotive sector and can be produced reliably and cost- and time-efficiently. If two joints are used for coupling the respective wheel carrier to a longitudinal link, it has proved advantageous for these joints to be fixedly coupled to the longitudinal member and thus for the wheel carriers to be connected to the axle. As a result, an Ackermann steering system is additionally realized.

According to another advantageous embodiment of the invention, there is provision that the transverse strut is designed to be rotationally flexible and flexurally resistant as a torsion profile. The flexurally resistant and rotationally flexible configuration of the transverse strut as a torsion profile particularly achieves a situation in which the transverse strut can very readily take up transverse forces as a result of the flexural resistance, but, on the other hand, torsion movements are also possible as a result of its rotationally flexible design so as in particular to be able to compensate for and absorb stresses which occur during steering.

Furthermore, it is also advantageous if the transverse strut designed as a torsion profile is designed to be bent, or curved, in particular upwardly curved. This configuration ensures that the distance of the roll center from the center of gravity of the motor vehicle is further minimized and thus is again reduced by the height difference. This embodiment of the invention also therefore ensures a further reduction in the rolling of the motor vehicle during cornering.

In particular when using the twist-beam axle as a steerable axle, it has proved to be advantageous for a steering gear to be mounted or arranged on the transverse strut. This ensures that the steering gear is arranged in a positionally fixed manner with respect to the twist-beam axle or body and thus no jamming can occur during rebound and compression since no effective movements of the steering gear occur with respect to the twist-beam axle, with the exception of minimum nondisturbing torsion movements of the crossmember. Here, there can of course also be provision that the steering gear is not arranged directly on the twist-beam axle or the body but that at least one auxiliary member is provided for this purpose.

Here, it has furthermore been proved to be advantageous for the steering gear to be operatively connected to the wheel carriers by means of steering linkages. Such a configuration of the twist-beam axle or of the steering gear makes it possible for the wheel carriers or the wheels arranged thereon to be able to be correspondingly moved by the steering gear in a simple manner.

According to a further advantageous embodiment of the invention, there is provision that the wheel carriers are operatively connected to an electric motor for driving the motor vehicle, in particular via corresponding shafts. This ensures that, with drivable wheel carriers of the twist-beam axle, they can be effectively and securely operatively connected to the electric motor provided for driving the motor vehicle.

Finally, an electrically driven motor vehicle in which at least one above-described twist-beam axle is used is also intended to be protected separately.

Here, it has proved to be particularly advantageous if the electrically driven motor vehicle has two above-described twist-beam axles, with these two twist-beam axles being arranged mirror-symmetrically to a central transverse plane of the motor vehicle, with preferably also the motor vehicle itself being designed to be mirror-symmetrical to its central transverse plane. The motor vehicle can thus move with the same driving behavior in both directions. This means that the vehicle strictly speaking would no longer have to turn around. That is because the two axles are of identical design and the driving behavior is thus not changed. A change of direction of travel is thus possible in a simple manner. This is in particular also supported if the entire motor vehicle is designed to be mirror-symmetrical with respect to its central transverse plane.

Further aims, advantages, features and application possibilities of the present invention will emerge from the following description of exemplary embodiments with reference to the drawings. Here, all the features described and/or illustrated form, on their own or in any desired expedient combination, the subject matter of the present invention, also irrespective of how they are summarized in the claims or how they relate back to preceding claims.

### BRIEF DESCRIPTION OF THE DRAWINGS

In the drawings:

FIG. 1 shows a plan view of a battery tray with exemplary embodiments of twist-beam axles or wheel suspensions according to the invention arranged thereon.

### DETAILED DESCRIPTION

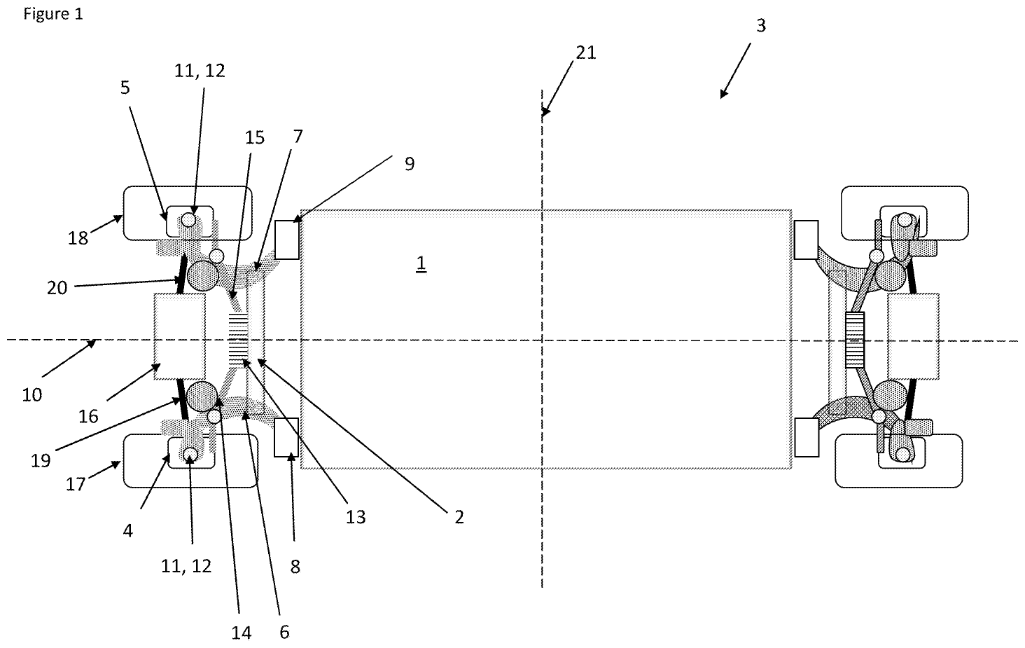

The single FIGURE, FIG. 1, shows a plan view of a battery tray 1 of a motor vehicle 3 driven by an electric motor 16 and having twist-beam axles according to the invention arranged on said vehicle. Here, in the illustration of FIG. 1, only the left twist-beam axle has been provided with reference signs, since the right twist-beam axle corresponds in design to the left, only in a mirror-inverted manner.

The twist-beam axle here consists substantially of two longitudinal links 6 and 7 which are connected to one another via a crossmember 2. The crossmember 2 is designed here as a flexurally rigid and rotationally flexible torsion profile. The longitudinal links 6 and 7 are arranged on and connected to the battery tray 1 by means of rubber bearings 8 and 9. At their ends opposite to the rubber bearings 8 and 9, the longitudinal links 6 and 7 have wheel carriers 4 and 5 on each of which a wheel 17 and 18 can be mounted.

The longitudinal links 6 and 7 are formed so as to be bent toward a motor vehicle longitudinal axis 10 between their two ends at which, on the one hand, the wheel carriers 4 and 5 and, on the other hand, the rubber bearings 8 and 9 are arranged. In the present exemplary embodiment, this bent shape of the longitudinal links 6 and 7 is necessary in order for the wheel carriers 4 and 5 or the wheels 17 and 18 arranged thereon to have sufficient play to carry out a steering movement.

To ensure that a corresponding steering movement of the wheel carriers 4 and 5 or of the wheels 17 and 18 can be carried out, a steering gear 13 is arranged or mounted on the crossmember 2. Corresponding steering linkages 14 and 15 extend from this steering gear 13 to the wheel carriers 4 and 5, with the result that the steering movement initiated by the steering gear 13 can be transmitted to the wheel carriers 4 and 5 or the wheels 17 and 18. To ensure that the wheel carriers 4 and 5 or the wheels 17 and 18 are steerable at all, the wheel carriers 4 and 5 are connected to respective longitudinal links 6 or 7 via a ball joint 11. In order to increase the ride comfort of the motor vehicle 3 here, a damper unit 12 is also additionally provided here.

To drive the motor vehicle, the electric motor 16 is provided which is connected to the respective wheel carrier 4 and 5 via corresponding shafts 19 and 20 and thus drives the motor vehicle 3 or the respective wheel carriers 4 and 5.

The twist-beam axle arranged on the left side of FIG. 1, which is designed as a front axle with the motor vehicle 3, is a driven axle. By contrast thereto, the twist-beam axle illustrated on the right in FIG. 1, which has not been provided with reference signs, is designed as a rear axle. In this present exemplary embodiment, this rear axle is nondriven here. Nondriven and driven axles here have different kinematics which a person skilled in the art will take into consideration in the manufacture of the corresponding axles.

In the present exemplary embodiment, the two axles of the motor vehicle 3 are designed to be identical and steerable, and they are arranged mirror-symmetrically to a central transverse axis of the battery tray 1 that is perpendicular to the motor vehicle longitudinal axis 10. Such an arrangement of this exemplary embodiment of the twist-beam axles is particularly appropriate for so-called people movers in urban public transportation, in particular if they move autonomously. The two steerable axles make such people movers or motor vehicles particularly maneuverable and also allow them to be maneuvered particularly well in the tightest of spaces.

The application of the twist-beam axles in a people mover, in particular if the two twist-beam axles are designed mirror-symmetrically to the central transverse plane 21 of the motor vehicle 3, allows the motor vehicle 3 to move in both directions with identical driving behavior. This means that the vehicle strictly speaking would no longer have to turn around. That is because the two axles are of identical design and thus the driving behavior is not changed. A change of direction of travel is thus possible in a simple manner. This is particularly also supported if the entire motor vehicle 3 is designed to be mirror-symmetrical with respect to its central transverse plane 21.

### LIST OF REFERENCE SIGNS

1 Battery tray
2 Crossmember
3 Motor vehicle
4 Wheel carrier
5 Wheel carrier
6 Longitudinal link
7 Longitudinal link
8 Rubber bearing
9 Rubber bearing
10 Motor vehicle longitudinal axis
11 Ball joint
12 Damper unit
13 Steering gear
14 Steering linkage
15 Steering linkage
16 Electric motor
17 Wheel
18 Wheel
19 Shaft
20 Shaft
21 Central transverse axis

What is claimed is:

1. A twist-beam axle for an electrically driven motor vehicle which is provided on the motor vehicle floor with at least one battery tray, comprising two longitudinal links which are each assigned to a wheel carrier of the axle and which are connected to one another via a crossmember and at one end of which a respective wheel carrier is arranged, wherein the longitudinal links, at the end opposite to the respective wheel carrier, are connected by means of rubber bearings to the at least one battery tray arranged on the motor vehicle floor, to a longitudinal member or crossmember in the floor region of the motor vehicle or to a frame of the motor vehicle.

2. The twist-beam axle as claimed in claim 1, wherein the longitudinal links between the respective wheel carrier and the respective rubber bearing are formed so as to be bent with respect to the motor vehicle longitudinal axis.

3. The twist-beam axle as claimed in claim 1, wherein the respective wheel carrier is coupled to the respective longitudinal link by means of a ball joint and a damper unit.

4. The twist-beam axle as claimed in claim 1, wherein the respective wheel carrier is coupled to the respective longitudinal link by means of two bearings or two joints.

5. The twist-beam axle as claimed in claim 1, wherein the crossmembers are designed to be rotationally flexible and flexurally resistant as torsion profiles.

6. The twist-beam axle as claimed in claim 5, wherein the torsion profile is designed to be bent or curved, in particular upwardly curved.

7. The twist-beam axle as claimed in claim 1, wherein a steering gear is mounted or arranged on the crossmember.

8. The twist-beam axle as claimed in claim 7, wherein the steering gear is operatively connected to the wheel carriers by means of steering linkages and/or track levers.

9. The twist-beam axle as claimed in claim 1, wherein the wheel carriers are operatively connected to at least one electric motor for driving the motor vehicle.

10. An electrically driven motor vehicle having at least one twist-beam axle as claimed in claim 1.

11. The electrically driven motor vehicle as claimed in claim 10, wherein two twist-beam axles are provided, these two twist-beam axles being arranged mirror-symmetrically to a central transverse plane of the motor vehicle, the motor vehicle itself preferably also being designed to be mirror-symmetrical to its central transverse plane.
